(19) United States
(12) Patent Application Publication
(10) Pub. No.: US 2012/0032774 A1
(43) Pub. Date: Feb. 9, 2012

(54) THERMAL FUSE RESISTOR, MANUFACTURING METHOD THEREOF, AND INSTALLATION METHOD THEREOF

(75) Inventors: Jong Il Jung, Busan (KR); Doo Won Kang, Anyang-si (KR); Gyu Jin Ahn, Ulsan (KR); Sung Kwang Kim, Ulsan (KR); Kyung Mi Lee, Ulsan (KR)

(73) Assignee: SMART ELECTRONICS INC., ULSNA (KR)

(21) Appl. No.: 13/265,741

(22) PCT Filed: Apr. 21, 2010
(86) PCT No.: PCT/KR10/02499

§ 371 Date: Oct. 21, 2011

(30) Foreign Application Priority Data
Apr. 21, 2009 (KR) 10-200-0034670

(51) Int. Cl. H01H 37/76; H01R 43/00

(52) U.S. Cl. 337/414; 29/825

(57) ABSTRACT

Disclosed are a thermal fuse resistor having a case injection-molded by using thermosetting resin having heat resistance less than that of filler, a manufacturing method of the thermal fuse resistor, and a method of installing the thermal fuse resistor such that a resistor and a thermal fuse are laid down on a printed circuit board. In the thermal fuse resistor, even if the case has a lighter weight and a thinner thickness by changing the material of the case as compared with those of a case according to the related art, the case is not easily broken, so that the case is suitable for the lightness and slimness of an electronic appliance employing the thermal fuse resistor. Since only the thickness of the case of the thermal fuse resistor is reflected to the thickness of the electronic appliance employing the thermal fuse resistor, the thermal fuse resistor is suitable for the slimness of the electronic appliance.

### TECHNICAL FIELD

The disclosure relates to a thermal fuse resistor, a manufacturing method thereof, and an installation method thereof. More particularly, the disclosure relates to a thermal fuse resistor suitable for the lightness and slimness of electronic appliances, a manufacturing method thereof, and an installation method thereof.

### BACKGROUND ART

In general, electrical circuits of large-size electronic appliances, such as an LCD TV and a PDP TV, include a protective device such as a thermal fuse resistor at a power input terminal in order to prevent appliance breakdown caused by an inrush current, the increase of an internal temperature or a continuous over current occurring when the electronic appliance is powered on, so that a power circuit may be protected.

The thermal fuse resistor includes a resistor and a thermal fuse, and the resistor is connected to the thermal fuse in series through lead wires.

In addition, according to the thermal fuse resistor, the resistor and the thermal fuse are packaged in a case to protect electronic parts from being damaged by fragments generated when the fusible member is melted, and fillers are filled in the case.

The fillers have the form of slurry and include silicon dioxide (SiO₂) to improve the heat-resistant, conductive and curing properties. The case is made of ceramic used in the case of a typical resistor.

An end of the lead wire extends out of the case, and the conventional thermal fuse resistor is mounted on a printed circuit board (PCB) such that the resistor and the thermal fuse are erected on the PCB by soldering the end of the lead wire on the PCB.

Accordingly, when an inrush current is introduced, the thermal fuse resistor restricts the inrush current to a predetermined current by using the resistor. When the over current is introduced, the thermal fuse resistor transfers heat emitted from the resistor to the thermal fuse through the filler to disconnect a circuit such that the fusible member provided in thermal fuse and including solid-phase lead (Pb) or polymer pellet is melted, thereby protecting electrical circuits of the electronic appliances.

### DISCLOSURE

### Technical Problem

However, since the conventional thermal fuse resistor, which has the case made of ceramic and the resistor erected on the PCB, has a limitation in reducing the thickness or the weight thereof, the thermal fuse resistor may be unsuitable for the lightness and slimness of electronic appliances.

In more detail, since ceramic has specific gravity greater than materials except for metals, the thermal fuse resistor having the case made of ceramic with greater specific gravity makes it difficult to reduce the weight of the electronic appliance equipped with the thermal fuse resistor.

In the case of an appliance such as an LCD TV or a PDP TV, the actual thickness of the appliance excluding an external frame and a liquid crystal is determined by a PCB in the frame and devices (e.g., thermal fuse resistor) mounted on the PCB. However, when the thermal fuse resistor is mounted on the PCB in a state in which the resistor is erected on the PCB like a conventional appliance, the whole length of the case is totally reflected to the thickness of the appliance. For this reason, the slimness of the electronic appliance employing the thermal fuse resistor is difficult to be realized.

The ceramic case is manufactured by sintering ceramic powder. If an inner wall of the case has the thickness of 1.5 mm or less due to the characteristic of ceramic having great brittleness, the ceramic case may easily be broken while carrying the case or manufacturing the case. In a sintering process, since typical ceramic represents an excessive compression rate of ±0.5 mm or more, the inner wall of the case has to be designed with the thickness of 2.5 mm or more by taking into consideration the compression rate to obtain the inner wall of the case having the thickness of 2.0 mm. Accordingly, as described above, in the conventional thermal fuse resistor, the thickness of the case cannot be effectively reduced due to the material characteristic of the case having great brittleness and excessively shrunken. This also serves as a factor to interrupt the slimness of an electronic appliance.

### Technical Solution

Accordingly, it is an aspect of the disclosure to provide a thermal fuse resistor suitable for the lightness and slimness of electronic appliances, a manufacturing method thereof, and an installation method thereof.

Additional aspects and/or advantages of the disclosure will be set forth in part in the description which follows and, in part, will be apparent from the description, or may be learned by practice of the disclosure.

The foregoing and/or other aspects of the disclosure are achieved by providing a thermal fuse resistor including a resistor, a thermal fuse disconnecting a circuit as heat is applied thereto from the resistor, a lead wire connecting the resistor with the thermal fuse in series, a case provided with an open surface used to receive the resistor and the thermal fuse therein in a state in which an end of the lead wire is drawn out of the case and provided at one wall surface thereof with a drawing groove used to draw the lead wire, and a filler filled in the case to bury the resistor and the thermal fuse therein and including silicon dioxide. The case is formed by injection-molding thermosetting resin having heat resistance less than heat resistance of the filler.

According to the disclosure, the resistor and the thermal fuse are provided in the case such that the resistor and the thermal fuse face the open surface side by side, and a wall surface of the case facing the open surface has a thickness in a range of about 0.5 mm to about 1.5 mm.

According to another aspect of the disclosure there is provided a manufacturing method of a thermal fuse resistor. The manufacturing method includes connecting a resistor and a thermal fuse to each other in series by using a lead wire, injection-molding a case to receive the resistor and the thermal fuse therein by using thermosetting resin, inserting the resistor and the thermal fuse into the case while drawing an end of the lead wire out of the case, filling the case, in which the resistor and the thermal fuse have been received, with a filler including silicon dioxide and having a form of slurry, and drying the filler.

According to still another aspect of the disclosure, there is provided an installation method of a thermal fuse resistor including a resistor, a thermal fuse disconnecting a circuit as heat is applied thereto from the resistor, a lead wire connecting the resistor with the thermal fuse in series, a case including thermosetting resin, an open surface used to receive the resistor and the thermal fuse therein in a state in which an end of the lead wire is drawn out of the case, a drawing groove used to draw the lead wire at one wall surface of the case, and a filler filled in the case to receive the resistor and the thermal fuse therein. The installation method includes soldering the lead wire drawn out of the case onto a printed circuit board, and bending a lead wire provided between the case and the printed circuit board to allow the open surface of the case to face the printed circuit board, so that the resistor and the thermal fuse are laid down on the printed circuit board.

### Advantageous Effects

As described above, in the thermal fuse resistor and the manufacturing method thereof according to the disclosure, the case is injection-molded by using thermosetting resin having heat resistance less than that of a filler of the case.

Therefore, the weight of the thermal fuse resistor according to the disclosure is reduced as compared with the weight of a case according to the related art. Even if the case has a thin thickness, the case may be prevented from being easily broken, so that the case may be suitable for the lightness and slimness of an electronic appliance employing the thermal fuse resistor.

In the installation method of the thermal fuse resistor according to the disclosure, the thermal fuse resistor faces the printed circuit board such that the resistor and the thermal fuse are laid down on the printed circuit board. Therefore, only the thickness of the case in the thermal fuse resistor is reflected to the thickness of the electronic appliance, so that the thermal fuse resistor becomes suitable for the sliminess of the electronic appliance employing the thermal fuse resistor.

### DESCRIPTION OF DRAWINGS

These and/or other aspects and advantages of the disclosure will become apparent and more readily appreciated from the following description of the embodiments, taken in conjunction with the accompanying drawings of which:

FIG. 1 is a perspective view showing the structure of a thermal fuse resistor according to one exemplary embodiment of the disclosure;

FIG. 2 is a flowchart sequentially showing the manufacturing procedure of the thermal fuse resistor according to one exemplary embodiment of the disclosure;

FIG. 3 is a perspective view showing a state after a device connection step has been completed in the manufacturing process of the thermal fuse resistor according to one exemplary embodiment of the disclosure;

FIG. 4 is a perspective view showing the structure of a case formed through i an injection-molding step in the manufacturing process of the thermal fuse resistor according to one exemplary embodiment of the disclosure;

FIG. 5 is a perspective view showing a state after a device insertion step has been completed in the manufacturing process of the thermal fuse resistor according to one exemplary embodiment of the disclosure;

FIG. 6 is a perspective view showing a state after a filler filling step has been completed in the manufacturing process of the thermal fuse resistor according to one exemplary embodiment of the disclosure;

FIG. 7 is a side view showing a state after a soldering step has been completed in an installation procedure of the thermal fuse resistor according to one exemplary embodiment of the disclosure; and

FIG. 8 is a side view showing a state after a bending step has been completed in the installation procedure of the thermal fuse resistor according to one exemplary embodiment of the disclosure.

### BEST MODE

Reference will now be made in detail to the embodiments of the disclosure, examples of which are illustrated in the accompanying drawings, wherein like reference numerals refer to the like elements. The embodiments are described below to explain the disclosure by referring to the figures.

Hereinafter, the structure of a thermal fuse resistor 1 and a manufacturing method thereof according to an exemplary embodiment of the disclosure will be described in detail with reference to accompanying drawings.

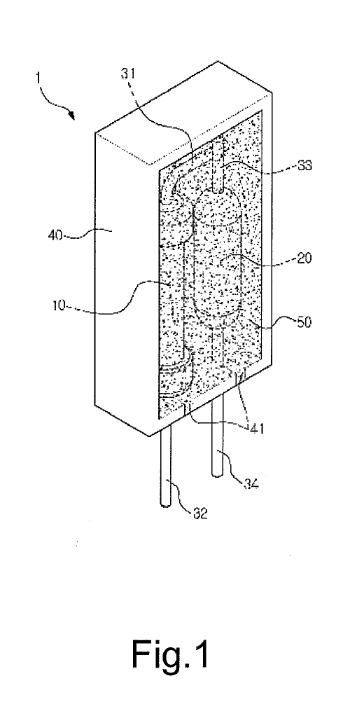

As shown in FIG. 1, the thermal fuse resistor 1 according to the present embodiment is employed in an electrical circuit of a large-size electronic appliance such as an LCD TV or a PDP TV, and includes a resistor 10, a thermal fuse 20 to disconnect a circuit by a heating-emitting action of the resistor 10, and lead wires 31, 32, 33, and 34 to connect the resistor 10 to the thermal fuse 20 in series.

The resistor 10 may be generally used as a cement resistor. The resistor 10 may be a device (e.g., negative temperature coefficient (NTC) for power) to restrict an inrush current. The resistor 10 may be formed by winding an alloy wire of copper (Cu) and nickel (Ni) around a ceramic rod such that the resistor 10 is not melted by a high current, but endures the high current. The first and second lead wires 31 and 32 are connected to both ends of the resistor 10.

The thermal fuse 20 may include a fusible member (not shown) wound around an insulating ceramic rod having a predetermined length. The lead wires 31, 32, 33, and 34 may include the third and fourth lead wires 33 and 34 electrically connected to conductive caps installed at both ends of the insulation ceramic rod. Since the various types of the thermal fuse 20 melted by the heat of the resistor 10 are generally known to those skilled in the art, details thereof will be omitted in order to avoid redundancy.

The first lead wire 31 of the resistor 10 is connected to the third lead wire 33 of the thermal fuse 20 in series through arc welding or spot welding.

In thermal fuse resistor 1, the resistor 10 and the thermal fuse 20 are packaged in a case 40 to protect electronic parts, which are mounted on a printed circuit board (PCB) 2 together with the thermal fuse resistor 1, from being damaged by fragments generated when the fusible member is melted, and a filler 50 are filled in the case 40.

The case 40 has one open surface such that the resistor 10 and the thermal fuse 20 are easy to be inserted therein. The case 40 has a hollow-type rectangular parallelepiped shape with a thickness less than a length such that the shape of the case 40 corresponds to the shape of the resistor 10 and the thermal fuse 20 provided in the shape of a rod. The resistor 10 and the thermal fuse 20 received in the case 40 face the open surface of the case 40 side by side. The case 40 is provided at one shorter wall surface thereof with a pair of drawing grooves 41 to draw the second and fourth lead wires 32 and 34 out of the case 40. Since the diameter of the resistor 10 is greater than the diameter of the thermal fuse 20, the depth of an internal receiving space 40a of the case 40 is slightly greater than the diameter of the resistor 10 such that the case 40 has a thin thickness.

The filler 50 includes silicon dioxide (SiO₂) by taking the heat-resistant, conductive and curing properties into consideration. The filler 50 is provided in the form of slurry and formed by mixing SiO₂ with silicon serving as an adhesive. Accordingly, the filler 50 is cured through a drying process in the case 40.

The thermal fuse resistor 1 having the above structure is mounted on the PCB 2 such that the second and fourth lead wires 32 and 34 drawn out of the case 4 are soldered on the PCB 2. Accordingly, when the inrush current is introduced, the thermal fuse resistor 1 restricts the inrush current to a predetermined current by using the resistor 10. When an over current is introduced, the thermal fuse resistor 1 transfers heat emitted from the resistor 10 to the thermal fuse 20 through the filler 50 to disconnect a circuit such that the fusible member including solid-phase lead (Pb) or polymer pellet provided in the thermal fuse 20 is melted, thereby protecting an electrical circuit of an electronic appliance.

In the thermal fuse resistor 1 according to the present embodiment, the case 40 is injection-molded by using thermosetting resin having heat resistance less than that of the filler 550 such that the thermal fuse resistor 1 is suitable for the lightness and the slimness of the electronic appliance employing the thermal fuse resistor 1.

In more detail, according to the thermal fuse resistor 1 of the present embodiment, since the resistor 10 and the thermal fuse 20 are buried in the filler 50, heat emitted from the resistor 10 is transferred to the thermal fuse 20 through the filler 50. Accordingly, the heat of the resistor 10 is directly transferred to the filler 50, and indirectly transferred to the case 40. Therefore, even if the case 40 is formed by using thermosetting resin having heat resistance less than that of the filler 50, the case 40 is not deformed or damaged due to the heat of the resistor 10, thereby preventing the performance of the thermal fuse resistor 1 from being degraded. The thermosetting resin does not degrade the performance of the thermal fuse resistor 1, and has specific gravity still less than that of ceramic forming a case of a thermal fuse resistor according to the related art, so that the weight of the thermal fuse resistor 1 may be reduced as compared with the thermal fuse resistor according to the related art. Therefore, the thermal fuse resistor 1 may be suitable for the lightness of the electronic appliance employing the thermal fuse resistor 1.

Since the thermosetting resin is not easily broken as compared with the ceramic, even if the case 40 has a thin thickness, the case 40 may be prevented from being damaged when the case 40 may be carried or manufactured. The injection molding is to inject resin molten material into the cavity of an injection mold and process the resin molten material to almost remove a compression rate, so that an error is controlled up to about ±0.1 mm or less.

Therefore, in the thermal fuse resistor 1 according to the present embodiment, the wall surface of the case 40 may be formed at a thickness in the range of about 0.5 mm to about 1.5 mm. Even if the case 40 has a thin inner wall as described above, the case 40 may be prevented from being damaged due to shock when the case 40 is carried or manufactured.

In an installation structure of the thermal fuse resistor 1 according to the present embodiment, which will be described below, the thickness of a wall surface of the case 40 facing the open surface of the case 40 exerts a direct influence on the thickness of the electronic appliance employing the thermal fuse resistor 1. Accordingly, all wall surfaces of the case 40 preferably have a thickness in the range of about 0.5 mm to about 1.5 mm when the lightness and the slimness of the electronic appliance employing the thermal fuse resistor 1 are taken into consideration. If only the slimness of the electronic appliance employing the thermal fuse resistor 1 is taken into consideration, only the wall surface facing the open surface may have a thickness in the range of about 0.5 mm to 1.5 mm.

The thermal fuse resistor 1 is designed through the following manufacturing process.

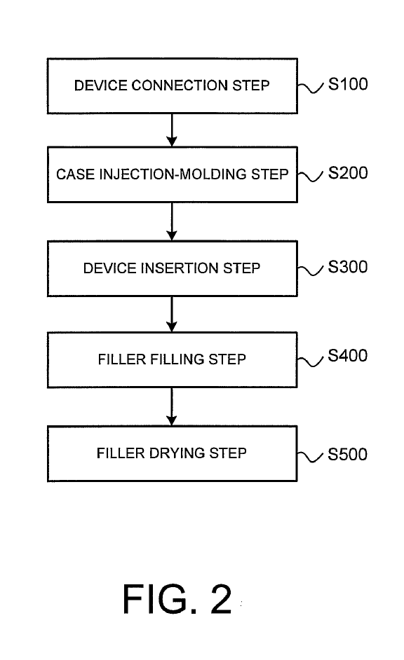

As shown in FIG. 2, the thermal fuse resistor 1 according to the present embodiment is manufactured through a device connection step (S100) of connecting the resistor 10 with the thermal fuse 20 in series by using the lead wires 31, 32, 33, and 34, a case injection-molding step (S200) of injection-molding the case 40 to receive the resistor 10 and the thermal fuse 20 therein by using thermosetting resin, a device insertion step (S300) of inserting the resistor 10 and the thermal fuse 20 into the receiving space of the case 40 while drawing the ends of the lead wires 32 and 34 out of the case 40, a filler filling step (S400) of filling the case 40, in which the resistor 10 and the thermal fuse 20 have been received, with the filler 50 including SiO₂ in the form of slurry, and a filler drying step (S500) of drying the filler 50 filled in the case 40.

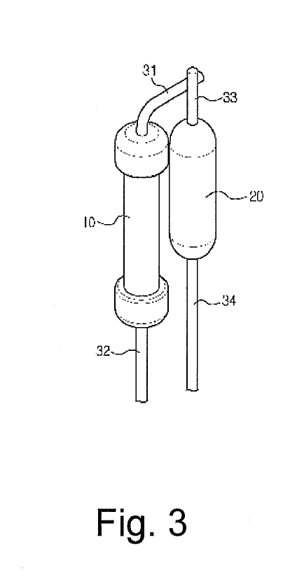

The device connection step S100 and the case injection-molding step S200 may be performed regardless of the sequence thereof. In the device connection step S100, as shown in FIG. 3, the end of the first lead wire 31 of the resistor 10 is connected to the end of the third lead wire 33 of the thermal fuse 20 in series through arc welding or spot welding.

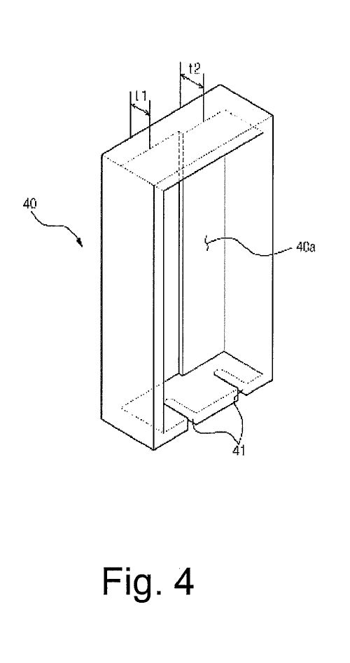

In the case injection-molding step S200, thermosetting resin molten material is injected into the cavity of the injection mold formed in the shape of the case 40 to injection-mold the case 40 having one open surface and provided with a pair of drawing grooves 41, which are used to draw the second and fourth lead wires 32 and 34, at one shorter inner wall of the case 40 as shown in FIG. 4. In this case, the thickness of the wall surface of the case 40 is in the range of about 0.5 mm to about 1.5 mm such that the slimness of the thermal fuse resistor 1 and the electronic appliance employing the thermal fuse resistor 1 may be realized. When the injection-molding is performed, the compression rate of the case 40 is almost removed so that an error may be controlled up to ±0.1 mm or less. Accordingly, the wall surface of the case 40 has the thickness as originally designed. Since the diameter of the resistor 10 is greater than that of the thermal fuse 20, the wall surface of the case 40 facing the open surface of the case 40 is thicker at the side of the resistor 10 than at the side of the thermal fuse 20 such that the resistor 10 and the thermal fuse 20 received in the receiving space 40a of the case 40 can be aligned with the same level. Therefore, according to the present embodiment, the wall surface of the case 40 facing the open surface of the case 40 has a thickness t1 of about 0.7 mm at the side of the resistor 10, and has a thickness t2 of about 1.2 mm at the side of the thermal fuse 20.

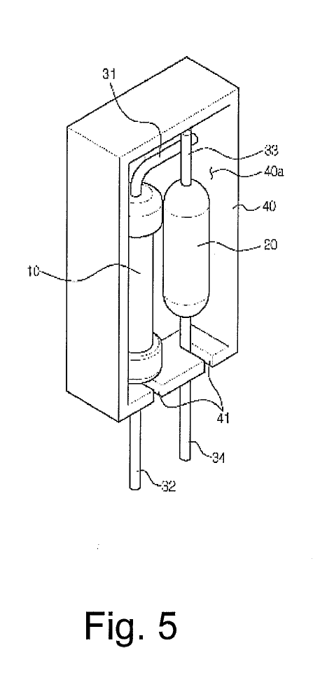

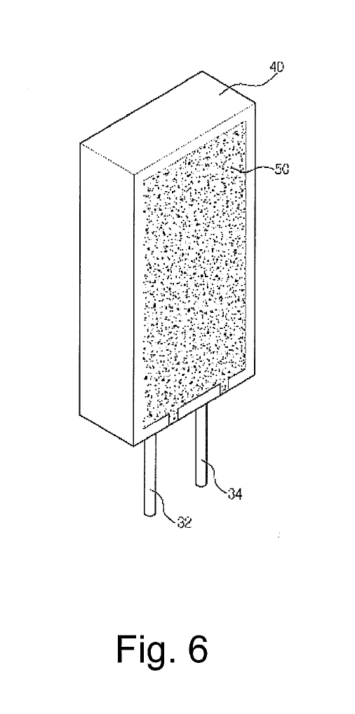

When the device connection step (S100) and the case injection-molding step (S200) have been finished, the device insertion step (S300) is performed. As shown in FIG. 5, the second and fourth lead wires 32 and 34 are drawn out of the case 40 through the drawing groove 41 in the device insertion step (S300), and the resistor 10 and the thermal fuse 20 are inserted into the receiving space 40a of the case 40 such that the resistor 10 and the thermal fuse 20 face the open surface of the case 40 side by side. Thereafter, in the filler filling step (S400), the filler 50 in the form of slurry is filled in the case 40 that have been subject to the device insertion step (S300) as shown in FIG. 6. The fuse resistor 1 that has been subject to the filler filling step (S400) is completely manufactured through the filler drying step (S500) of drying the filler 50 for one day or two days.

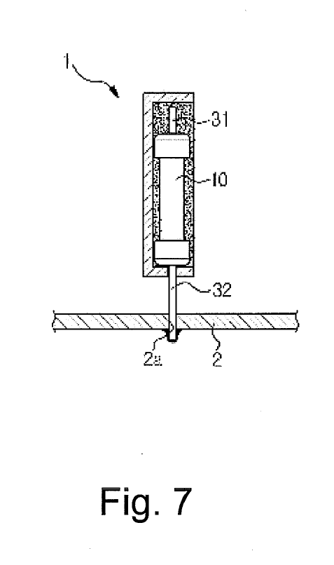

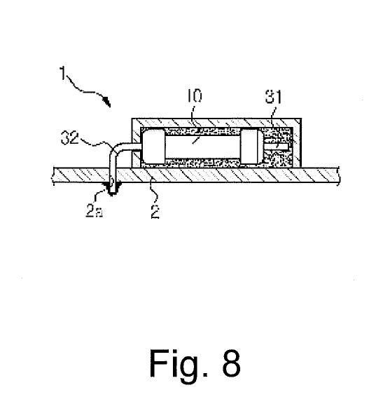

The thermal fuse resistor 1 according to the present embodiment is installed on the PCB 2 in the form different from that of a thermal fuse resistor according to the related art in order to realize the slimness of the electronic appliance. FIGS. 7 and 8 are views sequentially showing the installation procedure of the thermal fuse resistor 1 according to the present embodiment.

As shown in FIG. 7, when the thermal fuse resistor 1 according to the present embodiment is installed on the PCB 2, a soldering step is performed to fix the thermal fuse resistor 1 onto the PCB 2 by soldering a peripheral portion of an installation hole 2a in a state in which the second and fourth lead wires 32 and 34 drawn out of the case 40 are inserted into the insertion hole 2a. In this state, the resistor 10 and the thermal fuse 20 are erected on the PCB 2, and the case 40 is spaced apart from the PCB 2 with a predetermined distance due to the second and fourth lead wires 32 and 34. Then, as shown in FIG. 8, the thermal fuse resistor 1 is completely installed on the PCB 2 through a bending step of allowing the open surface of the case 40 to face the PCB 2 by bending the second and fourth lead wires 32 and 34 provided between the case 40 and the PCB 2, so that the resistor 10 and the thermal fuse 20 are put down on the PCB 2.

In the case of an appliance such as an LCD TV or a PDP TV, the real thickness of a product excluding an external frame and a liquid crystal is determined by the PCB 2 inside the frame and a device such as the thermal fuse resistor 1 mounted on the PCB 2. Therefore, if the thermal fuse resistor 1 according to the present embodiment is installed on the PCB 2 in a thickness direction such that the thermal fuse resistor 1 faces the PCB 2, only the thickness of the case 40 of the thermal fuse resistor 1 is reflected in the thickness of the electronic appliance. Accordingly, the installation structure of the fuse resistor 1 according to the present embodiment is more suitable for the slimness of an electronic appliance employing the thermal fuse resistor 1.

Although few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A thermal fuse resistor comprising:
a resistor;
a thermal fuse disconnecting a circuit as heat is applied thereto from the resistor;
a lead wire connecting the resistor with the thermal fuse in series;
a case provided with an open surface used to receive the resistor and the thermal fuse therein in a state in which an end of the lead wire is drawn out of the case and provided at one wall surface thereof with a drawing groove used to draw the lead wire; and
a filler filled in the case to bury the resistor and the thermal fuse therein and including silicon dioxide,
wherein the case is formed by injection-molding thermosetting resin having heat resistance less than heat resistance of the filler.

2. The fuse resistor of claim 1, wherein the resistor and the thermal fuse are provided in the case such that the resistor and the thermal fuse face the open surface side by side, and a wall surface of the case facing the open surface has a thickness in a range of about 0.5 mm to about 1.5 mm.

3. A manufacturing method of a thermal fuse resistor, the manufacturing method comprising:
connecting a resistor and a thermal fuse to each other in series by using a lead wire;
injection-molding a case to receive the resistor and the thermal fuse therein by using thermosetting resin;
inserting the resistor and the thermal fuse into the case while drawing an end of the lead wire out of the case;
filling the case, in which the resistor and the thermal fuse have been received, with a filler including silicon dioxide and having a form of slurry; and
drying the filler.

4. An installation method of a thermal fuse resistor including a resistor, a thermal fuse disconnecting a circuit as heat is applied thereto from the resistor, a lead wire connecting the resistor with the thermal fuse in series, a case including thermosetting resin, an open surface used to receive the resistor and the thermal fuse therein in a state in which an end of the lead wire is drawn out of the case, a drawing groove used to draw the lead wire at one wall surface of the case, and a filler filled in the case to receive the resistor and the thermal fuse therein, the installation method comprising:
soldering the lead wire drawn out of the case onto a printed circuit board; and
bending a lead wire provided between the case and the printed circuit board to allow the open surface of the case to face the printed circuit board, so that the resistor and the thermal fuse are laid down on the printed circuit board.
